(19) United States
(12) Patent Application Publication
(10) Pub. No.: US 2019/0187950 A1
(43) Pub. Date: Jun. 20, 2019

(54) ELECTRONIC DEVICE

(71) Applicant: Onkyo Corporation, Osaka (JP)

(72) Inventor: Susume TAKEMURA, Osaka (JP)

(21) Appl. No.: 16/213,236

(22) Filed: Dec. 7, 2018

(30) Foreign Application Priority Data
Dec. 19, 2017 (JP) 2017-242426
Nov. 5, 2018 (JP) 2018-207865

(51) Int. Cl. G06F 3/16; H04M 1/725

(52) U.S. Cl. CPC G06F 3/165; H04M 2250/02; H04M 1/7253

(57) ABSTRACT

An electronic device comprising: a first sensor which detects motion; a second sensor which detects proximity; and a controller which sets power of the electronic device ON when the electronic device is in a stand-by state, the first sensor detects motion and the second sensor detects proximity.

### CROSS-REFERENCE TO RELATED APPLICATIONS

This application claims priority to Japanese Application No. 2017-242426, filed Dec. 19, 2017, and Japanese Application No. 2018-207865, filed Nov. 5, 2018, the entire contents of which are incorporated herein by reference.

### FIELD

The present disclosure relates to a wearable type electronic device which is worn on a human body.

### BACKGROUND

In recent years, for example, a wearable type electronic device which is worn on a human body such as an arm or the like appears. In such a wearable type electronic device, when a user wears the electronic device on the human body, it is very convenient that power automatically becomes ON. For example, in a mobile device, there is an invention which controls ON/OFF of a back light with using a proximity sensor and an acceleration sensor (for example, see JP 2013-232804 A).

However, in the conventional wearable type electronic devices, when the electronic device is worn on the human body, there is not electronic devices which are automatically powered ON.

### SUMMARY OF THE INVENTION

According to one aspect of the disclosure, there is provided an electronic device comprising: a first sensor which detects motion; a second sensor which detects proximity; and a controller which sets power of the electronic device ON when the electronic device is in a stand-by state, the first sensor detects motion and the second sensor detects proximity.

### BRIEF DESCRIPTION OF THE DRAWINGS

FIG. 1 is a perspective view illustrating appearance of a wearable speaker according to an embodiment of the present disclosure.

FIG. 2 is a block diagram illustrating a constitution of a wearable speaker according to a first embodiment of the present disclosure.

FIG. 3 is a diagram illustrating operation of an acceleration sensor and so on.

FIG. 4 is a diagram illustrating a transition state of power of the wearable speaker.

FIG. 5 is a block diagram illustrating a constitution of a wearable speaker according to a second embodiment of the present disclosure.

FIG. 6 is a diagram illustrating a transition state of power of the wearable speaker.

### DETAILED DESCRIPTION OF THE PREFERRED EMBODIMENTS

An objective of the present disclosure is to provide an electronic device which is automatically powered ON when the electronic device is worn on the human body.

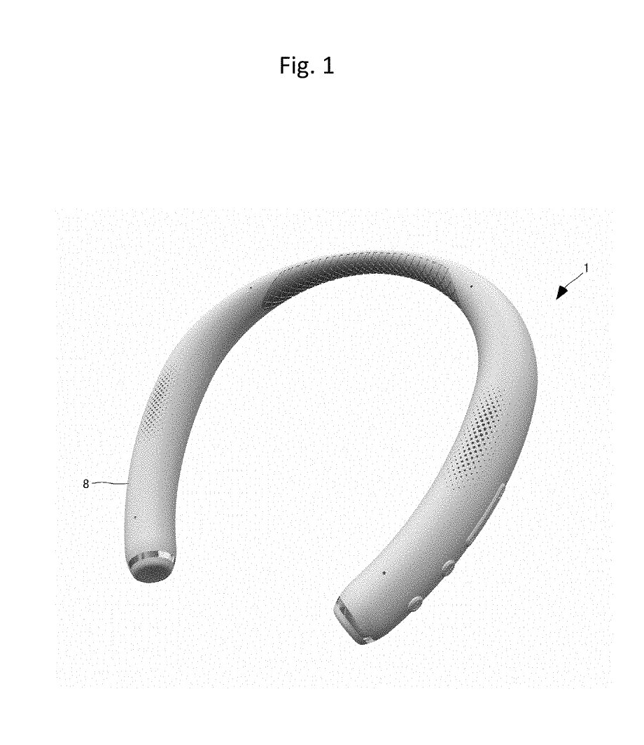

An embodiment of the present disclosure is described below. FIG. 1 is a perspective view illustrating appearance of a wearable speaker according to an embodiment of the present disclosure. As illustrated in FIG. 1, the wearable speaker 1 (electronic device) includes an almost U shape type enclosure 8 and is worn on a neck of a user. Namely, the wearable speaker 1 is a wearable type speaker which is worn on the neck of the user. For example, the enclosure 8 is made of resin.

### First Embodiment

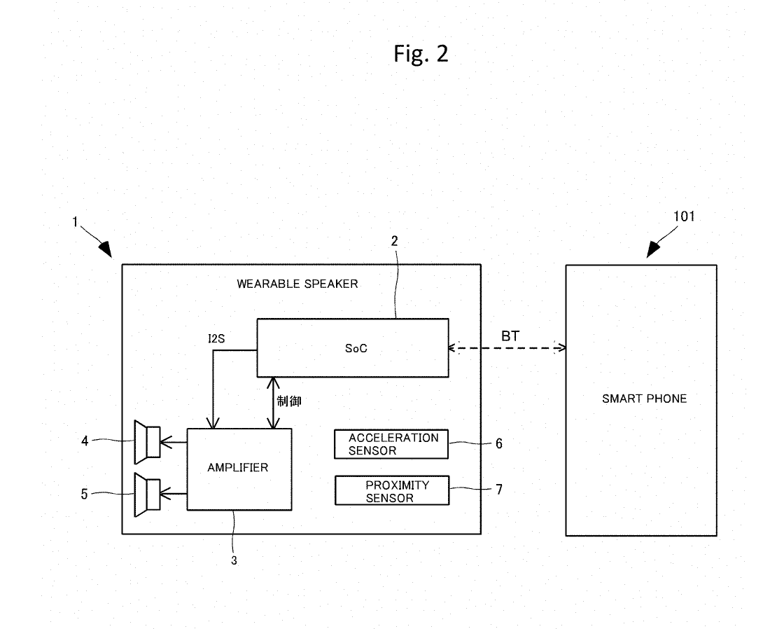

FIG. 2 is a block diagram illustrating a constitution of a wearable speaker according to a first embodiment of the present disclosure. The wearable speaker 1 performs wireless communication with a smartphone 101 according to Bluetooth (registered trademark) (hereinafter referred as to “BT”) standard. As illustrated in FIG. 2, the wearable speaker 1 includes an SoC 2 (System on Chip) 2, an amplifier 3, speaker units 4 and 5, an acceleration sensor 6, a proximity sensor 7 and so on.

The SoC 2 (controller) has a CPU (Central Processing Unit), a DSP (Digital Signal Processor), a memory and so on, and controls respective section composing the wearable speaker 1. Further, the SoC 2 has a BT communication function and performs BT wireless communication with the smartphone 101. For example, the SoC 2 receives an audio signal from the smartphone 101. The SoC 2 outputs the audio signal which is received from the smartphone 101 to the amplifier 3.

The audio signal of I2S system is output to the amplifier 3 from the SoC 2. The amplifier 3 amplifies the audio signal and outputs the amplified audio signal to the speaker units 4 and 5. An L channel audio signal is output to the speaker unit 4. An R channel audio signal is output to the speaker unit 5. The speaker units 4 and 5 output an audio based on the audio signal to external. In this manner, the wearable speaker 1 reproduces audio based on the audio signal which is output from the smartphone 101.

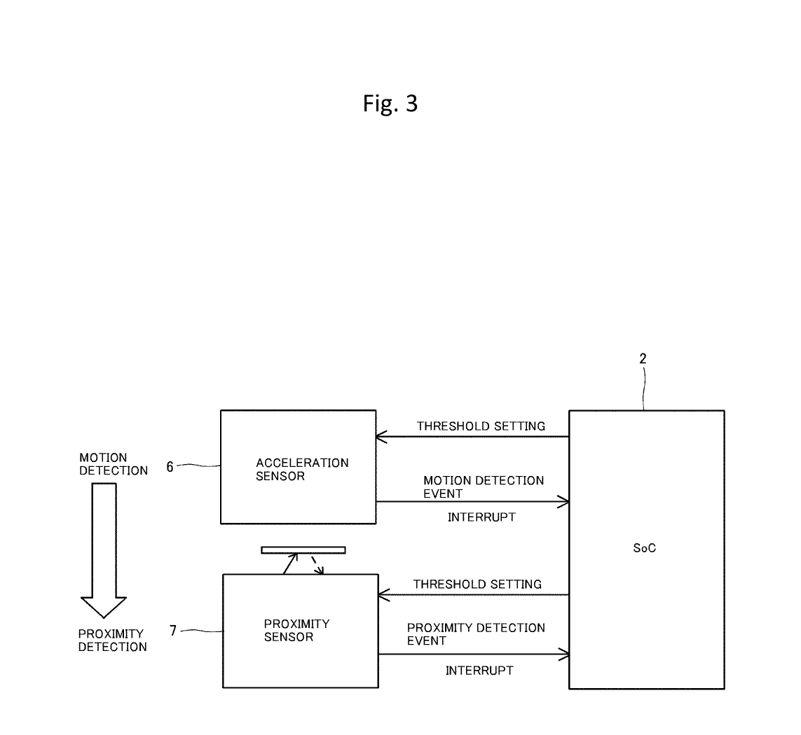

FIG. 3 is a diagram illustrating operation of the acceleration sensor and so on. The acceleration sensor 6 (first sensor) detects motion of the wearable speaker 1. For example, the acceleration sensor 6 is provided at any one of distal sides of the almost U shape enclosure 8 and in the enclosure 8. The acceleration sensor 6 is a three axis acceleration sensor. A threshold of the acceleration sensor 6 which detects motion can be set, and the SoC 2 sets the threshold. Even when power of the wearable speaker 1 is ON or OFF, the acceleration sensor 6 waits in a low electric power consumption state. When acceleration which exceeds the threshold occurs, the acceleration sensor 6 generates event pulse. For example, when the user takes up the wearable speaker 1 putted on a table or the like, acceleration not less than the threshold occurs, and the acceleration sensor 6 detects motion. In other words, the acceleration sensor 6 detects action that the user takes up the wearable speaker 1. Electric power consumption of the acceleration sensor 6 is less than the proximity sensor 7. When the threshold is exceeded by change of acceleration, the acceleration sensor 6 detects motion of the wearable speaker 1.

The proximity sensor 7 (second sensor) detects proximity of an object such as clothes or the like or a part of the human body such as a neck or the like. In a state that the wearable speaker 1 is hanged on the neck, the proximity sensor 7 is provided at a position which faces to the neck and in the enclosure 8. The proximity sensor 7 is a reflection type optical proximity sensor, flashes infrared rays, and detects proximity of the object or the like by reflected rays. A threshold of the proximity sensor 7 which detects proximity can be set, and the SoC 2 sets the threshold. For example, when the user wears the wearable speaker 1 on the neck, the neck comes close to the proximity sensor 7. For this reason, the proximity sensor 7 detects proximity of the neck. In other words, the proximity sensor 7 detects a state that the user wears the wearable speaker 1 on the neck. Further, electric power consumption of the proximity sensor 7 is more than the acceleration sensor 6.

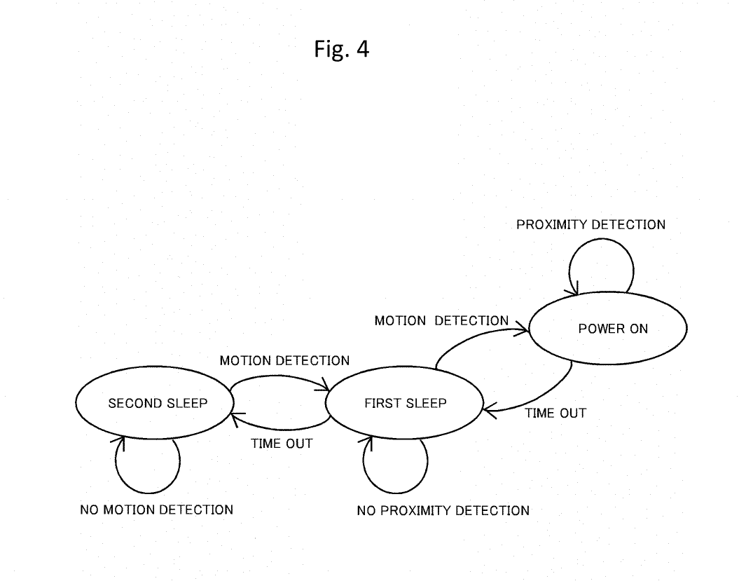

FIG. 4 is a diagram illustrating a transition state of power of the wearable speaker. Second sleep corresponds to a stand-by state of the wearable speaker 1 and is in a state that the wearable speaker 1 operates in low electric consumption. In the second sleep, only the acceleration sensor 6 is ON, and the others are in a sleep state. For example, the acceleration sensor 6 operates every second (intermittent operation). In the second sleep (when the wearable speaker 1 is in a stand-by state), when the acceleration sensor 6 does not detect motion, the wearable speaker 1 is still in the second sleep. In the second sleep, when the acceleration sensor 6 detects motion, the SoC 2 transits the wearable speaker 1 to first sleep. Namely, the SoC 2 sets the proximity sensor 7 ON, performs setting that the proximity sensor 7 operates every second, and sleeps. In the first sleep, the acceleration sensor 6 and the proximity sensor 7 operate every second.

In the first sleep, when the proximity sensor 7 does not detect proximity, the wearable speaker 1 is still in the first sleep. In the first sleep, when the proximity sensor 7 detects proximity, interrupt is applied to the SoC 2, and the SoC 2 becomes an operation state. Namely, the SoC 2 sets power of the wearable speaker 1 ON. After the SoC 2 sets power of the wearable speaker 1 ON, the SoC 2 performs wireless connection (BT) with the smartphone 101 (the other device) that pairing is set. When power of the wearable speaker 1 is ON and the proximity sensor 7 detects proximity, power of the wearable speaker 1 is still ON.

When power of the wearable speaker 1 is ON and the proximity sensor 7 does not detect proximity in a predetermined time, the SoC 2 transits the wearable speaker 1 to the first sleep (time out). In the first sleep, when the proximity sensor 7 does not detect proximity in a predetermined time, the SoC 2 transits the wearable speaker 1 to the second sleep.

Herein, in “stand-by state”, the wearable speaker 1 energizes and is in a low electric power consumption mode, and the SoC 2 (controller) operates with low clock (corresponding to the second sleep). Further, in a state of “power ON of the wearable speaker 1”, the wearable speaker 1 energizes and is in a normal mode, and the SoC 2 (controller) operates with normal clock.

As described above, in the present embodiment, when the wearable speaker 1 is in the stand-by state (second sleep), the acceleration sensor 6 detects motion, and the proximity sensor 7 detects proximity, the SoC 2 sets power of the wearable speaker 1 an ON state. When the wearable speaker 1 is in the stand-by state and the user takes up the wearable speaker 1 which is putted on a table or the like, motion is detected by the acceleration sensor 6. Further, when the user wears the wearable speaker 1 on the neck, proximity of the human body (for example, the neck which is a part of the human body) is detected by the proximity sensor 7. Thus, when the wearable speaker 1 is in the stand-by state, the SoC 2 sets power of the wearable speaker 1 ON. Therefore, according to the present embodiment, when the wearable speaker 1 is worn on the human body, power of the wearable speaker 1 can be automatically set ON.

Further, in the present embodiment, when the wearable speaker 1 is in the stand-by state, the proximity sensor 7 is OFF, and the acceleration sensor 6 detects motion, the SoC 2 sets the proximity sensor 7 ON. In this manner, when the wearable speaker 1 is in the stand-by state, electric power consumption can be reduced by setting the proximity sensor 7 in which electric power consumption is large OFF.

Further, in the present embodiment, after the SoC 2 sets power of the wearable speaker 1 ON, the SoC 2 performs wireless connection (BT) with the smartphone 101. Thus, according to the present embodiment, when the wearable speaker 1 is worn on the human body, wireless connection with the smartphone 101 can be automatically performed.

Further, when the user removes the wearable speaker 1 from the neck (human body), proximity of the human body (for example, the neck which is a part of the human body) is not detected by the proximity sensor 7. Thus, when power of the wearable speaker 1 is ON, the SoC 2 sets the wearable speaker 1 the stand-by state. Therefore, according to the present embodiment, when the wearable speaker 1 is removed from the neck (human body), the wearable speaker 1 can be automatically set to the stand-by state. Thus, electric power consumption in a case where the wearable speaker 1 is not used can be reduced.

### Second Embodiment

A second embodiment of the present disclosure is described below. In the second embodiment, with regard to the same constitution as the first embodiment, description is omitted.

In the first embodiment, two kinds of sleep modes (the first sleep and the second sleep) are generated by using the acceleration sensor 6 (motion sensor) and the proximity sensor 7. However, in the first embodiment, when the wearable speaker 1 in a soft bag or the like is carried, it is thought that motion and proximity are detected and the wearable speaker 1 becomes ON. In order to avoid this, it is thought that a hard case is attached to the wearable speaker 1 and proximity is not detected in the case. In the second embodiment, as a trigger that power of the wearable speaker becomes ON, voice is added.

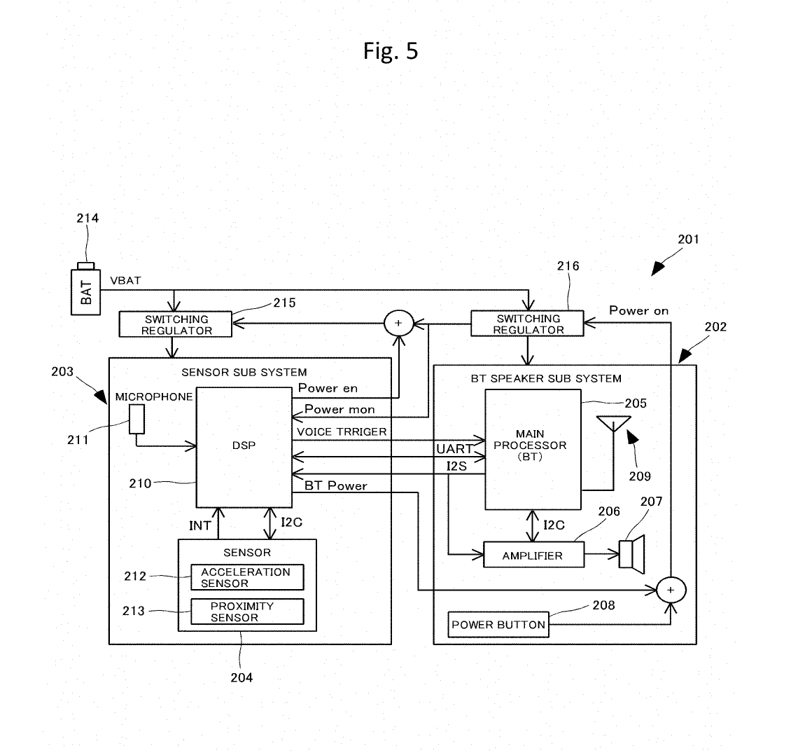

FIG. 5 is a block diagram illustrating a constitution of a wearable speaker according to the second embodiment of the present disclosure. As illustrated in FIG. 5, the wearable speaker 201 includes a BT speaker sub system 202 and a sensor sub system 203. The BT speaker system 202 performs wireless communication with a smartphone (not shown) according to BT standard and outputs an audio to external. The sensor sub system 203 includes a sensor 204 for setting power of the wearable speaker 201 ON.

The BT speaker sub system 202 includes a main processor 205, an amplifier 206, a speaker unit 207, a power button 208, and so on. The main processor 205 has an antenna 209 and performs wireless communication with the smartphone according to BT standard. For example, the main processor 205 receives an audio signal from the smartphone. The main processor 205 outputs the audio signal of I2S system to the amplifier 206. The amplifier 206 amplifies the audio signal which is output from the main processor 205 and outputs the amplified signal to the speaker unit 207. The speaker units 207 outputs the audio to external based on the audio signal. The power button 208 is a button for receiving power ON/OFF of the wearable speaker 201.

The sensor subsystem 203 includes a DSP (Digital Signal Processor) 210, the sensor 204, a microphone 211 and so on. The DSP 210 (controller) recognizes trigger voice (predetermined voice). The microphone 211 collects the audio. The audio which is collected by the microphone 211 is output to the DSP 210. The sensor 204 has an acceleration sensor 212 and a proximity sensor 213. The acceleration sensor 212 (first sensor) detects motion of the wearable speaker 1. The proximity sensor 213 (second sensor) detects proximity of object such as clothes or the like or a part of the human body such as the neck.

Power supply voltage from a battery 214 is supplied to the BT speaker sub system 202 and the sensor sub system 203 via switching regulators 215 and 216.

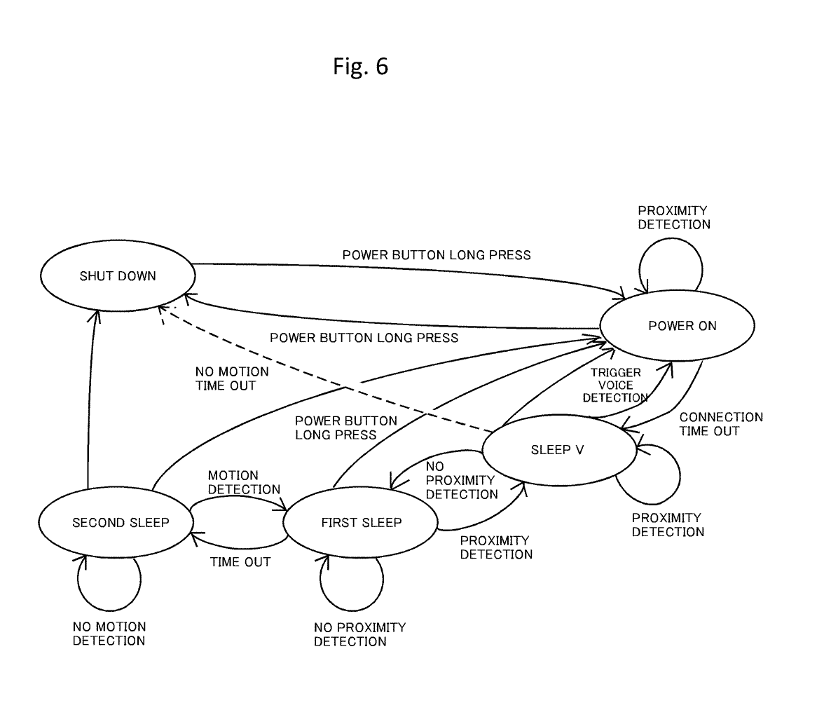

FIG. 6 is a diagram illustrating a transition state of power of the wearable speaker 201. In the second sleep, when the acceleration sensor 6 does not detect motion, the wearable speaker 1 is still in the second sleep. In the second sleep (the wearable speaker is in a stationary state), when the user takes up the wearable speaker 201, the acceleration sensor 6 detects motion and the DSP 210 transits the wearable speaker 201 to the first sleep. When the wearable speaker 201 is transited to the first sleep, the proximity sensor 213 begins sensing of a proximity state.

In the first sleep, when the proximity sensor 213 does not detect proximity, the wearable speaker 201 is still in the first sleep. In the first sleep, when the user wears the wearable speaker 201 on the neck, the proximity sensor 213 detects proximity and the DSP 210 transits the wearable speaker 201 to third sleep (sleep V). In the third sleep, the DSP 210 becomes a waiting state of voice input. In the third sleep, when the user speaks trigger voice (hot word), the DSP 210 recognizes the trigger voice and sets power of the wearable speaker 201 ON. In this time, the DSP 210 sets the main processor 205 ON. The main processor 205 begins connection with a paired device (for example, the smartphone).

When there is not the paired device, the main processor 205 only becomes ON and the wearable speaker 201 cannot connect to the device. When it is not possible to connect to the device (in vendor shipment where any device is not paired or the like), a signal which corresponds to long press of the power button is output, and the wearable speaker 201 automatically transits to a pairing mode. When the wearable speaker 201 cannot connect to the device, the wearable speaker 201 returns to the third sleep. The trigger voice is preferably voice for power ON, but may be voice which enables a voice recognition function.

Power of the BT speaker sub system 202 including the main processor 205 can be set ON or OFF by the power button 208 or control from the sensor sub system 203. When power of the BT speaker sub system 202 becomes ON, power of the sensor sub system 203 also becomes ON. Even if power of the BT speaker sub system 202 becomes OFF, power of the sensor sub system 203 can be maintained to ON by control from the sensor sub system 203, and in this state, three kinds of sleep modes (the second sleep, the first sleep, and the sleep V) operate.

Control of the sensor sub system 203 is performed by the DSP 210, and the DSP 210 monitors voice input from the microphone 211 and performs activation of the BT speaker sub system 202 by voice. In a state where the BT speaker sub system 202 activates, the DSP 210 monitors voice input, and when the DSP 210 detects the trigger voice, notifies it to the main processor 205, and sends a subsequent voice command by a communication means such as UART or the like.

Next, operation of the DSP 210 in the sleepmode is described. The DSP 210 senses that power of the main processor side is turned off by a Power mon signal, and becomes the sleep mode when power is turned off. The DSP 210 performs a state transition between sleep modes based on an event (interrupt signal) from the sensor 204 (the acceleration sensor 212 and the proximity sensor 213). In a waiting state of voice input, when there is voice input (trigger voice) of power ON, the DSP 210 generates a signal for activating the main processor 205. When the main processor 205 activates, the sleep mode ends.

As described above, in the present embodiment, the DSP 210 sets power of the wearable speaker 201 ON when the wearable speaker 201 is in the stand-by state, the acceleration sensor 212 detects motion, the proximity sensor 213 detects proximity, and the DSP 210 recognizes predetermined voice. Thus, even if the acceleration sensor 212 erroneously detects motion and the proximity sensor 213 erroneously detects proximity, it is prevented that power of the wearable speaker 201 becomes ON.

The embodiment of the present disclosure is described above, but the mode to which the present disclosure is applicable is not limited to the above embodiment and can be suitably varied without departing from the scope of the present disclosure as illustrated below.

In the above described embodiment, the SoC 2 controls the acceleration sensor 6 and the proximity sensor 7, and performs ON/OFF of the proximity sensor 7 based on detection of motion by the acceleration sensor 6 and power control and the like of the wearable speaker 1 based on detection of motion by the acceleration sensor 6 and detection of proximity by the proximity sensor 7. Not limited to this, a microcomputer which is different from the SoC 2 or the like may control the above described control and in cooperation with the microcomputer or the like and the SoC 2, the above described control may be performed.

In the above described embodiment, as a wearable type electronic device which is worn on the human body, the wearable speaker 1 which is worn on the neck is illustrated. Not limited to this, the electronic device may be a watch type wearable type electronic device which is worn on an arm. Further, the electronic device may be a wearable type electronic device of a headset, an earphone, or a headphone which is worn on an ear.

In the above described embodiment, as a sensor (first sensor) which detects motion, the acceleration sensor 6 is illustrated. Not limited to this, the sensor may be the other sensor which detects motion. Further, as a sensor (second sensor) which detects proximity, the proximity sensor 7 is illustrated. Not limited to this, the sensor may be the other sensor such as an illuminance sensor which detects proximity.

In the above described embodiment, the DSP 210 sets power of the wearable speaker 201 ON when the wearable speaker 201 is in the stand-by state, the acceleration sensor 212 detects motion, the proximity sensor 213 detects proximity, and the DSP 210 recognizes the predetermined voice. Not limited to this, the wearable speaker may include a sensor and a controller which sets power of the wearable speaker ON when the wearable speaker is in a stand-by state, the sensor detects, the controller recognizes predetermined voice. For example, the sensor is an acceleration sensor which detects motion, a proximity sensor which detects proximity or the like. In this case, even if the sensor performs erroneous detection, it is prevented that power of the wearable speaker becomes ON.

The present disclosure can be suitably employed in a wearable type electronic device which is worn on a human body.

What is claimed is:

1. An electronic device comprising:
a first sensor which detects motion;
a second sensor which detects proximity; and
a controller which sets power of the electronic device ON when the electronic device is in a stand-by state, the first sensor detects motion and the second sensor detects proximity.

2. The electronic device according to claim 1,
wherein the first sensor is ON and the second sensor is OFF when the electronic device is in the stand-by state, and
the controller sets the second sensor ON when the electronic device is in the stand-by state and the first sensor detects motion.

3. The electronic device according to claim 2,
wherein electric power consumption of the second sensor is more than the first sensor.

4. The electronic device according to claim 1,
wherein the controller sets power of the electronic device ON when the first sensor detects motion and the second sensor detects proximity within a predetermined time.

5. The electronic device according to claim 1,
wherein the controller performs wireless connection with the other device after the controller sets power of the electronic device ON.

6. The electronic device according to claim 1,
wherein the controller sets the second sensor OFF and sets the electronic device the stand-by state when power of the electronic device is ON and the second sensor does not detect proximity in a predetermined time.

7. The electronic device according to claim 1,
wherein the controller sets a threshold that the first sensor detects motion.

8. The electronic device according to claim 1,
wherein the controller sets a threshold that the second sensor detects proximity.

9. The electronic device according to claim 1,
wherein the first sensor is an acceleration sensor.

10. The electronic device according to claim 1,
wherein the second sensor is a proximity sensor.

11. The electronic device according to claim 1,
wherein the electronic device is a wearable type electronic device which is worn on a human body.

12. The electronic device according to claim 1,
wherein the electronic device is a wearable type electronic device which is worn on a neck.

13. The electronic device according to claim 1 further comprising: an almost U shape enclosure.

14. The electronic device according to claim 1,
wherein the electronic device is a wearable type electronic device which is worn on an arm.

15. The electronic device according to claim 1,
wherein the electronic device is a wearable type electronic device which is worn on an ear.

16. A control method of an electronic device comprising:
a first sensor which detects motion; and
a second sensor which detects proximity, and
configured to set power of the electronic device ON when the electronic device is in a stand-by state, the first sensor detects motion, and the second sensor detects proximity.

17. A storage medium in which a control program is stored, the control program of an electronic device comprising:
a first sensor which detects motion;
a second sensor which detects proximity; and
a controller, and the control program
allows the controller to set power of the electronic device ON when the electronic device is in a stand-by state, the first sensor detects motion, and the second sensor detects proximity.

18. The electronic device according to claim 1,
wherein the controller sets power of the electronic device ON when the electronic device is in the stand-by state, the first sensor detects motion, the second sensor detects proximity, and the controller recognizes a predetermined voice.

19. An electronic device comprising:
a sensor; and
a controller which sets power of the electronic device ON when the electronic device is in a stand-by state, the sensor detects, and recognizes a predetermined voice.
